(19) United States
(12) Patent Application Publication
(10) Pub. No.: US 2009/0071854 A1
(43) Pub. Date: Mar. 19, 2009

(54) INVENTORY CONTROL SYSTEM

(75) Inventor: William Wesley Martin, Pennyland (GB)

Correspondence Address: KNOBBE MARTENS OLSON & BEAR LLP, 2040 MAIN STREET, FOURTEENTH FLOOR, IRVINE, CA, 92614, US

(73) Assignee: Zeroshift Limited, Milton Keynes (GB)

(21) Appl. No.: 12/192,954

(22) Filed: Aug. 15, 2008

(30) Foreign Application Priority Data
Aug. 17, 2007 (GB) 0716108.6

(51) Int. Cl. B29C 35/08; B65D 85/00; G06Q 10/00; B29C 39/42

(52) U.S. Cl. 206/373; 705/28; 264/101; 427/299; 264/494

(57) ABSTRACT

An inventory control system and a method of manufacturing an item storage receptacle for the system is disclosed. The item storage receptacle has a plurality of individually-shaped recess for receiving specific inventory items. The storage receptacle may also have a monitoring feature for attaching a monitoring device configured to generate a signal for the system indicating whether the tool is present.

### CROSS REFERENCE TO RELATED APPLICATIONS

This Application claims priority to British Application No. GB0716108.6, filed Aug. 17, 2007, the specification of which is incorporated herein by reference.

### BACKGROUND

1. Field of the Invention

The field relates to a method for manufacturing an inventory item storage receptacle for an inventory control system and in particular, but not exclusively, to an inventory control system for monitoring the use of hand tools, surgical instruments and other items. The field also relates to an inventory control system including at least one of the storage receptacles.

2. Description of the Related Technology

An inventory control system may be useful when it is important to monitor the usage of hand tools, and to ensure that they are returned to storage after use. This can help to ensure that tools are not lost or stolen. Such a system is particularly important when tools are used for repairing or maintaining aircraft engines, as any tools left inside the engine after completion of the job could cause catastrophic damage. Similarly, in the case of surgical tools, it is essential to ensure that no tools are left inside a patient after an operation.

One method of monitoring the use of tools is to store the tools in a container having designated storage compartments for each and every specific tool. For example, the container may be a tool box having drawers with foam liner receptacles, with cut-outs for each of the tools. Using such a container, it is a relatively simple matter for a supervisor to check that all the tools are present by visually inspecting each drawer in turn, to ensure that all the spaces are filled.

However a problem with tool storage systems that use foam inserts is that to store new tools it is necessary to manufacture a new foam insert. This involves measuring the dimensions of the new tools, producing a drawing of the new layout and then cutting the new design into the foam. The process can be very time consuming. When you consider that some large companies have multiple tool cabinets (often hundreds and in some cases thousands), each with several drawers of tools, when there are regular tool changes, this can lead to substantial cost and disruption.

Also, foam is an expensive material, it is expensive to store the stock material since each insert is typically around 100 mm in depth, which requires a significant amount of storage space for large scale manufacturing operations, and it deteriorates quite quickly in use. Furthermore, for surgical applications, surgical instrument cabinets are often surgically steamed cleaned in an autoclave, wherein temperatures exceed 300 C and the materials are wetted. Foam inserts are not suitable for such cleaning processes and due to their porous nature may absorb harmful contaminants. In industrial settings the foam inserts may absorb other liquids such as oil and other chemicals which can look unsightly, may irritate the skin of a user and may corrode or dissolve the foam.

These problems also occur in tool cabinets that are intelligent, that is, tool cabinets that include some kind of sensor system to detect the presence of tools, such as the cabinet disclosed in WO 2005/028165.

### SUMMARY OF CERTAIN INVENTIVE ASPECTS

### BRIEF DESCRIPTION OF THE DRAWINGS

An embodiment of the invention Certain inventive aspects will now be described, by way of example, with reference to the accompanying drawings, in which:

FIG. 1 is a perspective view of a tool cabinet with an open tool drawer;

FIG. 2a is a perspective view from above of the drawer shown in FIG. 1;

FIG. 2b is an perspective view of the tool cabinet from the rear;

FIG. 3 is a plan view showing the layout of another tool drawer;

FIG. 4 is a view from below, showing the layout of tool sensors in the drawer shown in FIG. 3;

FIG. 5 is an enlarged perspective view of a swipe card access system, a local display and an input pad;

FIG. 6 is a flow diagram illustrating the steps in a vacuum forming process for producing a tool container liner for storing tools therein;

FIG. 7 is a flow diagram illustrating the steps in a moulding process for producing a tool container liner for storing tools therein;

FIG. 8 is a schematic diagram illustrating the main components of an inventory control system; and

FIG. 9 is a flow diagram showing the main steps of an inventory control process.

### DETAILED DESCRIPTION OF CERTAIN INVENTIVE EMBODIMENTS

Certain embodiments seek to provide a method for manufacturing an inventory item storage receptacle and a inventory control system including the storage receptacle.

According to some embodiments a method for manufacturing an inventory item storage receptacle for an inventory control system includes at least one of said storage receptacles, a monitoring system for monitoring the removal and replacement of the inventory items from the storage locations, and a data processing system for recording the removal and replacement of inventory items from the recesses according to signals received from the monitoring system, wherein the storage receptacle includes a plurality of inventory item storage locations, wherein each of the storage location comprises an individually-shaped recess for receiving a specific inventory item, the shape of the recess being matched to the shape of the inventory item, said method including providing a quantity of mouldable material to form a body for the receptacle, moulding the mouldable material around each of the inventory items to be stored in the receptacle, or blanks/equivalents thereof, thereby forming individually-shaped recesses in the body that are matched to the inventory items, and setting the mouldable material to fix the shape of the receptacle.

This provides a quick and easy way of replacing a storage receptacle, such as a tool storage tray or drawer liner. It is a process that can be carried out by owners of the inventory control system rather than having to go back to the original manufacturer.

The mouldable material can be sheet plastics material and the process can include heating the plastics material above an activation temperature to render it into a mouldable condition. The plastics sheet material may be, for example polypropylene, acrylonitrice butadiene styrene, high impact polystyrene, high density polyethylene, polyethylene terephtalate glycol, polycarbonate, acrylic and polyaliphatic carbonate. Many plastics sheet materials typically cost less than foam to purchase and storage costs are reduced since typically the material is much thinner. Plastics materials are typically much more robust than foam and do not absorb materials that are spilt on to them. Also, for surgical applications, selecting the appropriate plastics material enables any tool cabinets in which it is used to be subjected to an autoclave process. Since plastics materials are typically non-absorbent and non-porous they are significantly more hygienic than foam for surgical instrument apparatus.

Advantageously the method can include using a vacuum forming process to mould the mouldable material around the inventory items, or blanks/equivalents thereof. The vacuum forming process typically includes placing each of the inventory items, or blanks/equivalents thereof, on the deck of the vacuum forming machine. The inventory items, or blanks/equivalents thereof, are arranged to provide the desired layout of recesses in the receptacle. Typically the inventory items are arranged to lie substantially within the same plane such that the depth of the recess substantially matches the depth of the inventory items. The plastics material is heated up until it is mouldable and is then laid over the deck of the vacuum forming machine and the air is evacuated thereby sucking the material to lie over the inventory items in a tight fitting manner, thus forming the storage receptacle having recesses that match the shape of the inventory items. Typically a thermoforming plastics material is used. The thermoplastic material is set by cooling to a temperature below its moulding temperature. Typically the receptacle will be cooled to room temperature.

Advantageously, the method can include forming at least one finger access recess. The or each finger access recess is substantially contiguous with the inventory item recess and is arranged to enable a user to more easily prise the inventory item from its recess.

The method can include, as a pre-step to the moulding process, producing a blank or formation that can be placed adjacent to the inventory item to form the finger access recess. Alternatively, a suitable blank of the inventory item can be formed with an additional formation to provide the or each finger recess.

Advantageously, the method can include forming formations in the inventory item recesses that are arranged to retain the inventory item in the recess and/or to provide tactile feed back to a user removing the inventory item from the recess. For example, each formation may comprise any one of the following: a substantially continuous overhanging lip around the rim, one or more lip portions extending partially around the rim, an undercut portion, a protrusion or rib in a side wall the recess. The formations can be produced during the moulding process by providing an appropriate blank.

The method can include forming a monitoring feature in the mouldable material that is arranged for receiving equipment associated with the inventory item monitoring system, such as a through hole. Advantageously the hole can be formed during the moulding process, for example the or each tool blank may include a protrusion to create a hole or additional recess in the sheet material for a sensor (see below). Alternatively the hole can be provided by a subsequent drilling or cutting procedure.

Advantageously, the method can include forming inventory item identification indicia in the receptacle. For example, during the moulding processes inventory item names, codes or other identifiers be formed in the moulded body of the receptacle. In the art, it is known to adhere labels to foam inserts, however the labels are often torn during use or the printed text fades with time. Forming the or each identifier in the tool storage receptacle structure overcomes the need for such labels and makes a much more robust sign. The indicia can be produced by assembling a line of embossed characters adjacent an inventory item such that when the vacuum forming process takes place, the words/code is formed in the moulded material. Where necessary, reversed embossed characters can be used. The indicia can be used for visual inspection and can also be used as monitoring features for monitoring systems that have an optical character recognition capability.

Advantageously, monitoring features may be formed, whereby a monitoring device is connected to the receptacle. Such features may include, for example, a recess, a hole, or a protrusion.

Advantageously the method can include texturing the or each recess and/or the surrounding material to provide an improved visual contrast between the recesses and the surrounding material. This makes it easier for visual and machine optical inspections as to whether a tool is present or absent. Advantageously the method may include texturing the or each tool blank.

Advantageously, the method can include using first and second sheets of mouldable material layered one on top of the other and removing portions of one of the sheets after moulding to expose the other material. This provides a contrast in texture and/or colour between the recesses and the surrounding material and assists visual and machine optical inspections to determine whether a tool is present or absent.

Advantageously, the method can include coating the receptacle with pigment, paint, dye, ink or similar in order to produce contrasting colours for the recesses and the surrounding material.

Advantageously, the method can include forming at least one recess in a portion of a deformable material by forcing the or each tool into the material to create the or each recess. Advantageously the or each recess formed in the material is substantially complementary to the tool in at least the plan view. Typically, each recess is substantially prismatic. The material can be arranged to substantially retain the shape of the or each recess formed therein after the tool has been removed. For example, the material can be substantially solid and plastically deformable, such as a clay or gel like substance. Advantageously the method can include treating the material in order to fix the shape of the or each recess. The material may be treated to make it substantially rigid at least in the locale of the or each recess, so that inserting and extracting the tool does not distort the shape of the recess. The material can be cured, for example by exposure to air, heat, light, UV light, or by addition of a curing agent. Additionally, or alternatively, the material can be coated with a hardenable material such as a resin. This increases the durability of the tool holder. Any suitable material can be used, for example clay, which can be fired to retain the shape of the or each recess, a curable gel or polymer such as curable silicone gel, polymer gel or epoxy resins and hardening catalysts that can be hardened by, for example, exposure to air, heat, light, UV light or a curing agent, or a paste that can be dried by exposure to air and/or heat.

The method may include placing a flexible layer of material, such as a fabric or film, over the deformable material before pushing the inventory item into the material. This helps to release the tool from the recess and prevents the tool from becoming soiled. For example, the fabric may include lycra® or latex® and the film can be made from an impervious polymer such as polythene.

The monitoring system can include at least one of a sensor system; a camera system and image recognition means; a camera system with optical character recognition means; and at least one barcode reading device. The sensor system preferably includes a plurality of sensors for sensing the presence of inventory items in the recesses, each sensor being associated with a recess and located in or adjacent to its recess and arranged to generate a signal representing the presence or absence of an inventory item in the associated recess. Each sensor can be, for example, an optical sensor or a magnetic sensor. The data processing system is constructed and arranged to identify the inventory items from the signals received from the monitoring system.

The inventory control system can include an enclosure for housing the or each tool storage receptacle. Preferably, the enclosure comprises a container and the container includes a plurality of storage compartments. Preferably each compartment includes at least one tool storage receptacle. For example, the container can include a plurality of drawers and each drawer can include one of the storage receptacles in the form of a liner or tray.

The inventory control system can include an access system for controlling access to the inventory items that includes an input device for entering the identity of a user. This makes it possible to monitor the tool usage of individual workers and ensure best working practices. Also, if a tool goes missing, it is possible to identify who last had possession of that tool. The access control system can include a locking mechanism for controlling access to the inventory items and at least one user identification device to enable a user to log into the access control system. Each user identification device can comprise: a swipe card, a chip and pin card, an RFID tag, a RuBee tag or a proximity device, and the input device comprises a compatible reading device.

Advantageously, the method is applicable to inventory items comprising tools.

Preferably the inventory control system includes a container, the monitoring system includes sensing means for sensing the presence of tools, said data processing system being constructed and arranged to receive signals from the sensing means and to record the removal and replacement of tools according to the received signals, said sensing means including a plurality of sensors for sensing the presence of tools in the recesses, each sensor being located in or adjacent a recess and arranged to generate a signal representing the presence or absence of a tool in the associated recess, said data processing system being constructed and arranged to identify the tools from the received signals according to the recesses with which the sensors are associated. The data processing system can include means for recording the time of removal and replacement of tools and may be located remotely from the container and is connected to the container by a data link. The container can include a local indicator device for indicating the presence and/or absence of tools in the container.

According to another aspect, an inventory control system includes at least inventory item storage receptacle having moulded body including a plurality of inventory item storage locations, wherein each of the storage locations comprises an individually-shaped recess for receiving a specific inventory item, the shape of the recess being matched to the shape of the inventory item, a monitoring system for monitoring the removal and replacement of the inventory items from the storage locations, and a data processing system for recording the removal and replacement of inventory items from the recesses according to signals received from the monitoring system.

Advantageously, the moulded body of the storage receptacle comprises sheet material with the recesses moulded therein.

Advantageously, the storage receptacle is substantially non-absorbent and non-porous. The inventors have discovered that it is the porous and absorbent nature of the foam that can lead to significant corrosion of the recesses, for example by accidental spillage of hydraulic fluid. Advantageously the storage receptacle is substantially rigid.

Preferably, the storage receptacle is made from a plastics material. Advantageously the storage receptacle can be made from polypropelene, acrylonitrice butadiene styrene, high impact polystyrene, high density polyethylene, polyethylene terephtalate glycol, polycarbonate, acrylic and polyaliphatic carbonate.

Advantageously, each inventory item recess can include formations that are arranged to retain the inventory item in the recess and to provide tactile feed back to a user removing the inventory item from the recess and/or replacing it therein. For example, the formations can include at least one of the following: a substantially continuous overhanging lip around the rim, one or more lip portions around the rim, an undercut portion, at least one protrusion or rib in a side wall of the recess. The formations can be produced during the moulding process by providing an appropriate blank.

The receptacle may include a plurality of through holes for receiving equipment associated with the inventory item monitoring system. Preferably each recess includes a through hole in its base for receiving a monitoring device or electrical connections associated with the monitoring device.

Advantageously, the receptacle can include inventory item identification indicia in or adjacent each recess. For example, during the moulding processes inventory item names, codes or other identifiers be formed in the moulded plastic tool storage tray.

Advantageously, the storage receptacle can include textured areas in each recess and/or on the material surrounding each recess to provide an improved visual contrast between the recesses and the surrounding material.

Advantageously, the receptacle can include first and second sheets of mouldable material layered one on top of the other, with portions of one of the first and second sheets having been removed to expose the other of the first and second sheets.

Advantageously, the receptacle can be coated with paint, dye, ink or similar in order to produce contrasting colours for the recesses and the surrounding material.

Advantageously, the receptacle can be made from a deformable material, wherein the recesses have been formed by forcing the or each tool into the material and then treating the material to fix the shape of the recesses. Advantageously the or each recess formed in the material is substantially complementary to the tool in at least the plan view. Typically, each recess is substantially prismatic. The material is arranged to substantially retain the shape of the or each recess formed therein after the tool has been removed. For example, the material can be substantially solid and plastically deformable, such as a clay or gel like substance. In order to fix the shape of the or each recess the material may be treated to make it substantially rigid at least in the locale of the or each recess, so that inserting and extracting the tool does not distort the shape of the recess, for example by exposure to air, heat, light, UV light, or by addition of a curing agent. Additionally, or alternatively, the material can be coated with a hardenable material such as a resin. This increases the durability of the tool holder. Any suitable material can be used, for example clay, which can be fired to retain the shape of the or each recess, a curable gel or polymer that can be hardened by, for example exposure to air, heat, light, UV light or a curing agent, or a paste that can be dried by exposure to air and/or heat.

The monitoring system can include at least one of a sensor system; a camera system and image recognition means; a camera system with optical character recognition means; and at least one barcode reading device. The sensor system can include a plurality of sensors for sensing the presence of inventory items in the storage locations, each sensor being associated with a storage location and arranged to generate a signal representing the presence or absence of an inventory item in the associated storage location. At least some of the sensors may consist for example of magnetic or optical sensors, for sensing the presence of ferromagnetic materials. Such sensors have the advantage of being cheap, robust and simple.

The system monitors which tools have been removed from and replaced into the container, and indicates the presence and/or absence of the tools. This makes it easy to assess whether all the tools taken from the container have been returned after use, thus reducing the risk of any tools being inadvertently left behind. Safety in situations such as aircraft engine maintenance is thus significantly improved. Certain aspects also reduce the risk of tools being lost or stolen, since the fact that a tool has gone missing can be indicated immediately. The system also makes it possible to monitor which tools are being taken for any specified task, thereby helping to ensure best practice in maintenance operations.

Since the tool storage locations comprise a set of individually-shaped recesses for receiving the tools, thus ensuring that tools are always returned to the correct storage locations, it makes it possible for the system to identify which tools have been removed, without requiring the use of sophisticated sensors and tagging devices on the tools. It also allows a visual check of the tools to be completed very easily, by looking for any empty recesses. This provides a manual backup to the automatic system, allowing the full complement of tools to be confirmed easily, even in the event of a power failure or other fault. Preferably, the recesses are colour-coded, to simplify further the visual checking process.

Advantageously, the inventory control system can include an enclosure for housing the receptacle having a closure member that can be opened and closed by a user in order to gain access to the inventory items. Preferably the enclosure comprises a container having a plurality of storage compartments.

Advantageously, the system can include an access system for controlling access to the inventory items, said access system including an input device for entering the identity of a user, a locking mechanism for controlling access to the inventory items in the enclosure and at least one user identification device to enable a user to log in via the input device. Each user identification device can comprise: a swipe card, a chip and pin card, an RFID tag, a RuBee tag or a proximity device, and the input device comprises a compatible reading device. Advantageously the locking mechanism is arranged to automatically open when an authorised user has been identified.

The data processing system can be arranged to record the time of removal and replacement of inventory items and the time that the user logs in/logs out. The data processing system can be located remotely from the enclosure and if so is connected to the monitoring system by a data link, and optionally a local computer. Advantageously the enclosure can include a local indicator device for indicating the presence and/or absence of inventory items in the enclosure.

The data processing device may be located remotely from the container and may be connected to the container by a data link, for example a wired link, an optical link (e.g. using infrared light) or a radio link. The data processing device may also be positioned locally, for use in the workplace. Alternatively, the container may include a local indicator device for indicating the presence and/or absence of tools in the container.

The tool cabinet 2 shown in the Figures includes a steel cabinet housing 4, which may be static or mobile (for example, it may be mounted on castors), four tool drawers 6a-6d, the top drawer 6a being shown pulled out in FIG. 1, four micro-switches 8a-d, a computer processing device 13, a local display 14, a data transmission unit 16, a power supply unit 18, and a backup electrical supply in the form of a rechargeable cell 20.

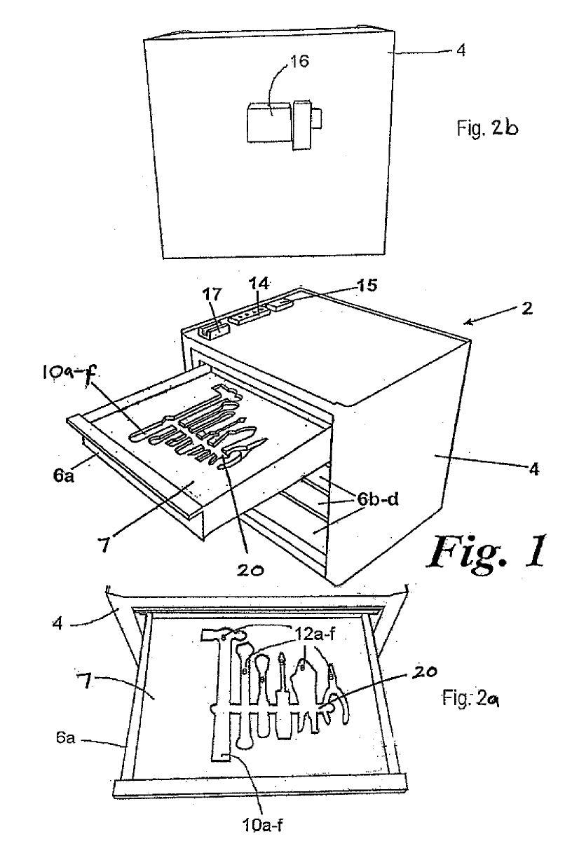

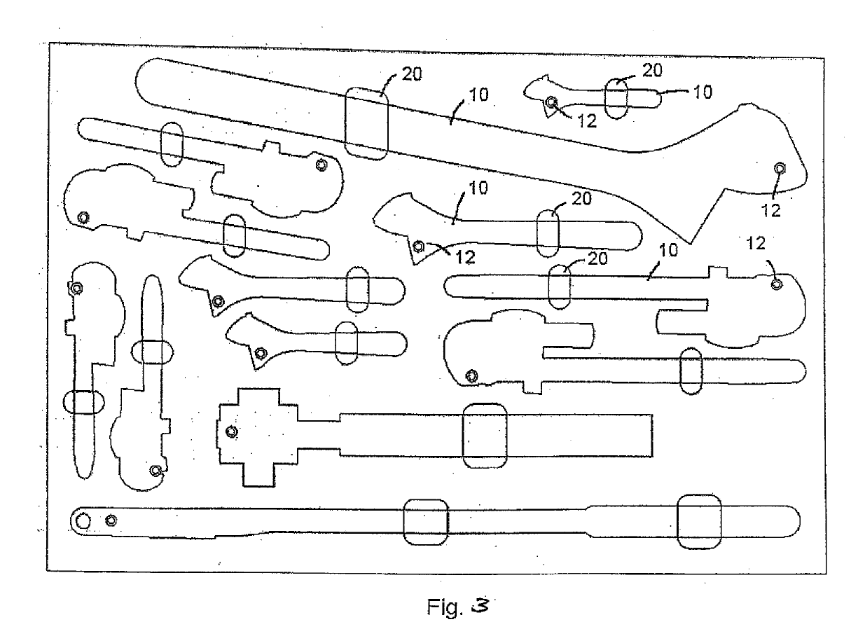

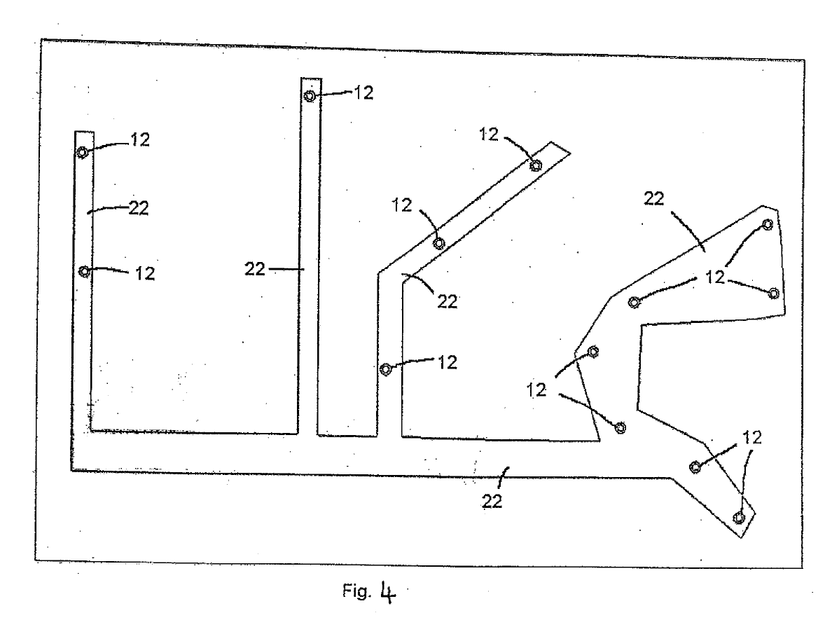

Each drawer 6a-d includes a liner 7, for example of a rigid foam material, having a number of cut-out compartments (or recesses) 10a-f, which are shaped to receive specific tools. FIGS. 1 and 2a show a first layout of recesses 10. The recesses are preferably colour-coded, to provide a simple visual indication that a tool has been removed. For example, the recesses may have a bright colour (e.g. yellow), while the top surface of the drawer liner has a contrasting colour (e.g. black). The liner 7 also includes at least one additional recess 20 that provides a finger hole to enable a user to more easily remove tools from the recesses 12a-f.

FIG. 3 shows an alternative drawer layout, with a number of tool compartments 10 and sensors 12. Each of the compartments also includes a finger recess 20, allowing the tool to be easily removed from or replaced in the appropriate recess 10. The sensors 12 are interconnected by means of a printed circuit 22, as shown in FIG. 4.

Each of the micro-switches 8a-d is connected to the computer device 13. Each micro-switch 8a-d is associated with one of the four drawers 6a-6d and is arranged to be activated when its associated drawer is closed. Thus from the signals received from the micro-switches 8a-d, the computer device 13 knows when the tool cabinet 2 is open, when it is closed, and which drawer 6a-d has been opened.

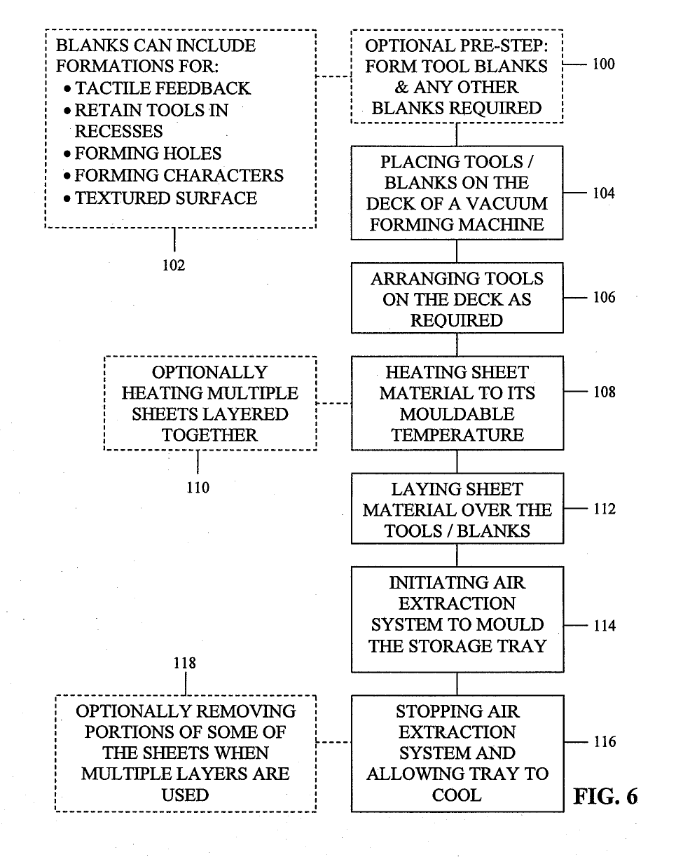

The liner 7 may be formed in a vacuum forming process (see FIG. 6). This includes using substantially rigid sheet plastics materials that can be moulded when heated. Initially, a tool blank 100 can formed for each of the tools that are to be stored in the liner 7, by a suitable process, such as vacuuming forming the tool or alternatively using a suitable machining process. Each tool blank (or each tool itself) is then arranged on the mounting deck 104 of a vacuuming forming machine in the layout required. The sheet material is then heated 108 until it reaches a temperature which softens the material sufficiently such that it can be deformed by the forces generated by the vacuum. The material is pulled over the tool blanks 112 and the vacuum 114 is created to suck the material around the blanks (or tools). This deforms the sheet material. The material is allowed to cool 116. When the material has cooled the recesses 10a-10f are fixed into the sheet material.

Optionally, the tools blanks may include 102 a formation to create a hole or additional recess in the sheet material for a sensor (see below). The tool blanks may include means for creating a formation in the recess to enable the user of the tool system to remove the tool from the recess. For example, each tool blank can include a formation to provide the finger recesses 20 contiguous with their respective tool recess 10. Alternatively, separate blanks can be created to provide these features.

Optionally, the tool blanks can include 102 formations to produce tool identification indicia, such as tool name, code or some other identifier which can be formed in the moulded plastic tool storage receptacle. Alternatively the indicia can be formed into the moulded product in the material that surrounds the recesses 10a-10f.

Optionally, to improve later visual inspection to determine whether a tool is present or not, the moulding can be textured in the recesses 10a-f and/or the surrounding material to provide an improved visual contrast between the recesses and the surrounding material. This can be achieved by texturing the tool blanks or alternatively by including an additional moulding component, or components, to achieve the desired texture. For example, the recesses 10a-10f can be very smooth and the surrounding material rippled or similar. Alternatively, the recesses 10a-10f can be roughened or rippled and the surroundings can be smooth.

Optionally, first and second sheets of mouldable material layered one on top of the other 110 can be used during the vacuum forming process. This enables parts of one of the materials to be removed 118 to expose the other material such that there is a contrast in texture and/or colour between the recesses 10a-10f and the surrounding material. This assists visual inspections to determine whether a tool is present or absent.

Optionally, the recesses 10a-10f can be formed in the moulding process to at least partially lip over the or each tool blank. This provides tactile feedback to the user when inserting or removing a tool and also provides some grip to retain the tool in the recess 10a-10f.

Instead of creating tool blanks, the plastics sheet can be moulded around examples of the tools to be stored in the insert 7, or the exact tools themselves.

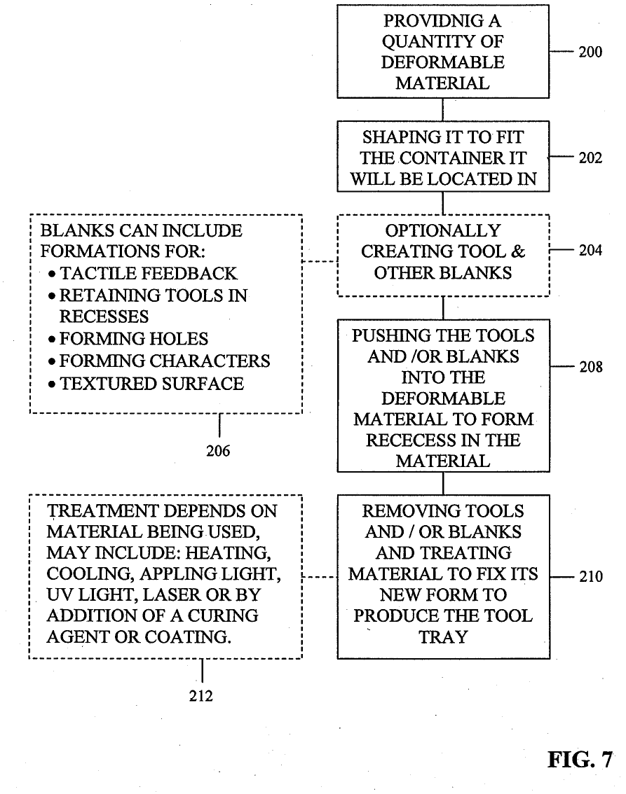

Alternatively, the liner 7 can be made from a layer of a plastically deformable material, such as clay 200 (see FIG. 7) arranged to fit into the drawer 202. Each tool (or a tool blank 204,206) is pushed 208 into the clay to form a complementary recess 10a-10f in the plan view. The tools are removed 210 from the layer of clay. A finger recess is formed adjoining each tool recess 10a-10f to enable a user of the tool cabinet to lift each tool from its recess 10a-10f. Optionally, a flexible layer such as a layer of fabric or a film can be placed between the clay and tool before pushing the tools into the clay so that the tools can be more easily removed and do not become soiled. When the tools are removed, holes are formed in the base of each recess 10a-10f to receive sensors (see below). When all of the recesses 10a-10f and holes have been formed, the clay is fired 210 to harden the liner 7 and fix the positions of the recesses 10a-10f such that inserting and removing the tools does not damage the liner 7 by deforming the recesses 10a-10f. Either before or after firing, the base of each recess, and optionally the upper surface of the liner 7 can be painted to produce a contrast between the recesses and upper surface.

Alternatively, the liner 7 can be produced from a semi-solid material such as a paste, gel or polymer 200,202, preferably using a flexible layer of material on at least its upper surface (see FIG. 7). The recesses 10a-10f are formed in a similar manner to the clay liner described above 204,206,208. However, setting or curing the material 210,212 can be by exposure to heat, light, UV light or by addition of a curing agent as appropriate for the type of material used. For example, a UV curable resin can be used in conjunction with a flexible transparent film. Each tool can be pushed into the resin whilst sitting on the film and UV light can be applied to cure the resin through the film. If the material cannot retain its shape prior to curing, it may be necessary to keep the tool in place until after the curing process.

Sensor holes can be formed in the liner 7 after the solidification process has taken place.

Within or adjacent to each compartment 10, a sensor 12a-12f is provided, which senses the presence in the compartment of a tool. The sensors may for example be Hall effect sensors, to detect the ferromagnetic materials such as iron or steel, from which most tools are made. Alternatively, other types of sensor can be used, including for example optical sensors, mechanical contact switches and so on. Each sensor is arranged to detect the removal and replacement of a tool in its associated recess and the signals are sent to a remote computer system 26, which records which tools have been removed/replace and the time that the event occurred.

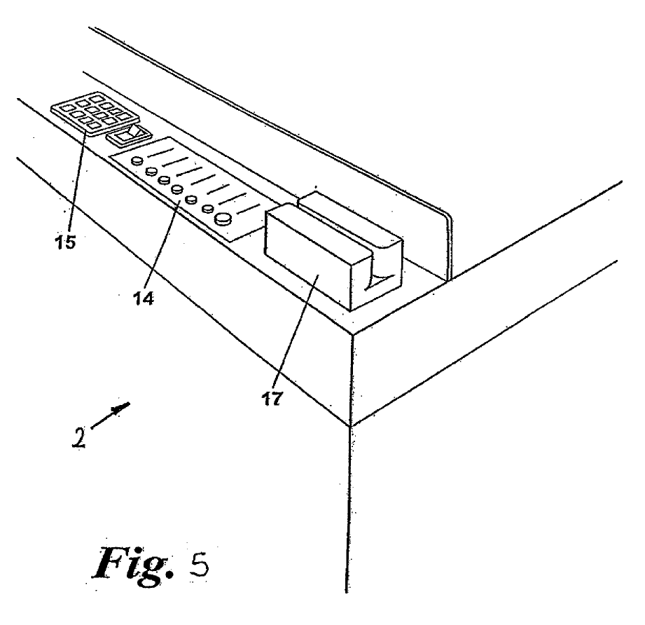

The tool cabinet 2 also includes an electrically operated lock 30 for the drawers, which can be activated using a key, a personal identification number (PIN) via an input pad 15, or a swipe card system 17 containing data identifying the user (see FIG. 5). This allows the identity of the user to be monitored each time the tool cabinet 2 is opened. The computer system 26 is arranged to record the identity of the user each time a tool is taken or removed so that if a tool is missing a supervisor knows who was last to handle the tool. This data can be stored in a database of tool usage. Optionally, the computer device 13 can be arranged to prevent operation of the monitoring system when the lock 30 is open. In this instance, the sensors 12 will only operate when all the drawers 6a-d are closed.

The input pad 15 can be used to input other data, such as a part number or to select options on a menu system.

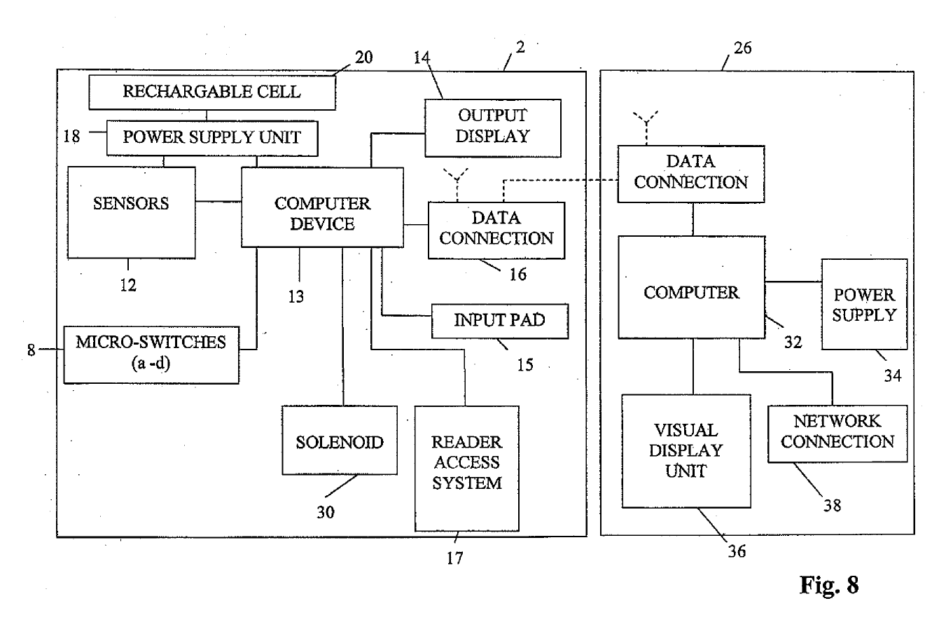

The main components of an inventory control system, which includes the tool cabinet 2 described above, are shown schematically in FIG. 8. The system includes the tool cabinet 2 and the remote computer system 26, which is connected to the cabinet 2 via the data transmission unit 16. The computer system 26 includes a central processing unit 32, a power supply 34 and a visual display unit 36 and optionally a network connection 38. The computer system 26 includes a database of all the tools stored in the cabinet 2.

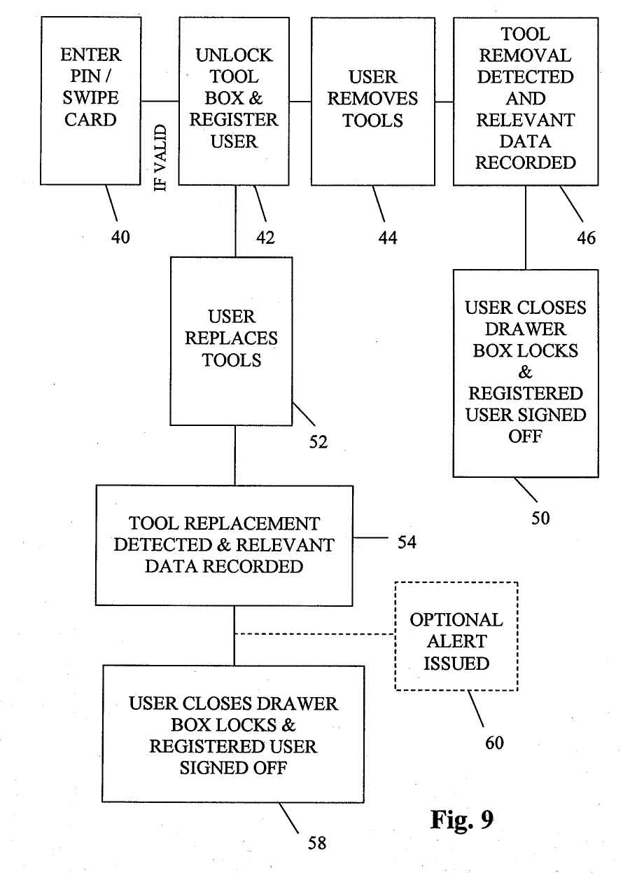

An inventory control process carried out using the system described above will now be described with reference to FIG. 9. First, a user (for example a technician or a mechanic) identifies him or herself 40 by entering a PIN or using a swipe card. The identity of the user is checked against a list of authorised users held on the computer system 26 and if authorisation of the user is valid, the lock 30 to the tool cabinet is unlocked 42, allowing the user to gain access to the tools. At the same time, the identity of the user and the time are recorded 42 in the computer system 26 database. If the identity of the user is not validated as that of an authorised user, the tool cabinet 2 remains locked, preventing access to the tools. Optionally, a warning may be sent to the computer system 26 to indicate that an unauthorised person has attempted to gain access.

Assuming that the identity of the user has been validated, the user then opens one of the drawers 6a-6d. The user then removes 44 the required tools from the cabinet 2. As this takes place, for each of the tools removed, the sensor 12 associated with the recess 10 sends the received signals to the computer system 26 via the computer device 13. The computer system 26 determines which tools have been removed by the association of the sensor 12 with the recess and a database of tools associated with the recesses. This information is recorded 46, together with the time of removal and a user identifier. After the user has closed the cabinet, after a short delay, the cabinet relocks automatically and the registered user is signed off 50.

After completing the assigned task, the user re-enters his/her ID 40, and once this has been verified, the cabinet unlocks 42 and the identity of the user is registered on the computer system 26. The user opens the appropriate drawer 6a-6d, replaces 52 each of the tools in the cabinet and closes the drawer. For each tool that is replaced, the sensor 12 sends signals to the computer system 26 for identification, and another entry is made in the database 54, identifying replacement of the tool, the time and the identity of the user. If the computer system 26 determines that no tools have been replaced, it issues an alert 60, which enables a supervisor to investigate the incident.

The user then closes the cabinet and is logged off 58.

The computer 26 therefore records which tools are in use, who has taken them and the time at which the tools are removed and returned. Using this information it is a simple matter for a supervisor to check whether all the tools are present in the cabinet and, if any are missing, who has taken them and when. The supervisor can also check that the tools taken for a particular task are appropriate for that task. Checks can be carried out by the supervisor whenever required or they can be instigated automatically, for example whenever the cabinet is closed. In addition the tool cabinet can be checked visually at regular intervals, to ensure the full complement of tools is present and that the automatic system is operating correctly. The computer 26 can also keep a continuous log of how long each tool has been in use, which may be useful for tools and measuring instruments such as torque wrenches that have to be recalibrated at preset intervals. The supervisor can also use the information as part of a schedule management system, which assigns an amount of time to a particular task. If the tool is not returned within a certain period an alert can be issued. This can provide an early indication that a tool is missing or that a particular job is overrunning. The system can also be programmed to disregard the absence of tools that have been removed deliberately for repair or replacement. The computer can also keep a continuous log of how long each tool has been in use, which may be useful for tools and measuring instruments such as torque wrenches that have to be recalibrated at preset intervals. It can also be programmed to disregard the absence of tools that have been removed deliberately for repair or replacement.

It may be noted that although the system checks for the presence of a tool in each of the sensed recesses, it does not check that the correct tool has been placed in each recess. In fact, since in the embodiment described above the detectors are simple magnetic detectors, it would be relatively easy to mislead the detection system, for example by placing a steel bolt in one of the recesses instead of the correct tool. This is not considered to be a serious disadvantage, since the main aim of the system is to ensure that trusted personnel do not accidentally forget to return tools to the container after use, rather than preventing deliberate theft. However, it is worth noting that since the system also records who has taken each tool from the container, this will deter deliberate theft, particularly if regular visual inspections of the cabinet are also carried out.

If necessary, the system can be adapted to include more sophisticated sensors that are capable of detecting the presence of individual tools, for example by detecting identification tags attached to the tools. However, this is generally less preferred, since it increases the cost and complexity of the system and gives rise to other disadvantages, such as the difficulty of attaching tags to the tools and the risk of the tags becoming detached during use. The simple system described first is likely therefore to be preferred in many situations.

Various other modifications of the inventive aspects described herein are, of course, possible. For example, instead of using magnetic sensors to detect the presence of tools in each of the recesses, other types of sensor such as optical sensors or mechanical switches may be used. Alternatively, instead of providing a separate sensor for each recess, the cabinet may include an array of optical sensors mounted above each drawer, which scan the drawer as it is opened, in a manner similar to a conventional optical scanner. An image of the drawer can then be generated, which can be compared with previous images to sense the removal of tools from the recesses or their replacement in the recesses. Alternatively, instead of optical sensors, an array of magnetic sensors can be used to scan the drawer as it is opened. Other systems such as a camera system and image recognition software; a camera system and optical character recognition software; or barcode reading devices can be used to monitor the removal and replacement of tools from the recesses.

The tool container may also take different forms: for example it may consist of a box with a single layer of tools, or with tools in removable trays, or it may take the form of a cupboard or a board on or within which the tools are hung, or any other suitable form. The tools may also of course be of any kind, including engineering tools, surgical tools and so on. The above described features and aspects may also be adapted to other non-tool applications where an inventory control system is required, and references within this specification to tools should be construed accordingly to include equivalent items in suitable non-tool applications. The invention may for example be used for inventory taking or stock taking/control purposes.

While the above detailed description has shown, described, and pointed out novel features as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others.

What is claimed is:

1. A method for manufacturing an inventory item storage receptacle for an inventory control system, the system including at least one of said storage receptacles, a monitoring system for monitoring the removal and replacement of the inventory items from the storage locations, and a data processing system for recording the removal and replacement of inventory items from the recesses according to signals received from the monitoring system, the method comprising:
providing a quantity of mouldable material to form a body for the receptacle:
moulding the mouldable material with the shape of each of the inventory items to be stored in the receptacle, wherein individually-shaped recesses in the body that are matched to the inventory items are formed; and
setting the mouldable material to fix the shape of the receptacle.

2. The method according to claim 1, further comprising forming a monitoring feature in the receptacle.

3. The method according to claim 2, wherein the monitoring feature comprises a through hole.

4. The method according to claim 2, wherein the monitoring feature comprises an item identification indication.

5. The method according to claim 1, wherein the mouldable material includes sheet plastics material and the method further comprises heating the plastics material above an activation temperature to render it into a mouldable condition.

6. The method according to claim 5, including using a vacuum forming machine to mould the mouldable material.

7. The method according to claim 1, including forming at least one finger access recess for each inventory item recesses.

8. The method according to claim 7, including, producing a blank or formation that can be used to form the finger access recess.

9. The method according claim 1, including forming formations in the inventory item recesses that are arranged to retain the inventory item in the recess and to provide tactile feed back to a user removing the inventory item from the recess.

10. The method according to claim 9, including forming at least one of the following for each recess: a substantially continuous overhanging lip that extends around the rim of the recess, one or more lip portions arranged to extend partially around the rim, an undercut portion, and at least one protrusion or rib in a side wall of the recess.

11. The method according to claim 1, including forming a through hole in the mouldable material for receiving equipment associated with the inventory item monitoring system.

12. The method according to claim 1, including forming inventory item identification indicia in the receptacle.

13. The method according to claim 1, including texturing the recess and/or the surrounding material to provide an improved visual contrast between the recesses and the surrounding material.

14. The method according to claim 1, including using first and second sheets of mouldable material layered one on top of the other and removing portions of one of the sheets after moulding to expose the other sheet.

15. The method according to claim 1, including coating the receptacle with pigment, paint, dye, ink or similar in order to produce contrasting colours for the recesses and the surrounding material.

16. The method according to claim 1, including forming at least one recess in a portion of a deformable material by forcing an object having the shape of the tool into the material to create the or each recess.

17. The method according to claim 16, wherein the material is arranged to substantially retain the shape of the recess formed therein after the object has been removed.

18. The method according to claim 16, including treating the material in order to fix the shape of the recess.

19. The method according to claim 18, wherein the material is cured. by exposure to at least one of air, heat, light, UV light, and a curing agent.

20. The method according to claim 16 including placing a flexible layer of material over the deformable material before forcing the object into the material.

21. The method according to claim 16, wherein the object is the tool.

22. The method according to claim 1, wherein the inventory items are tools.

23. An inventory control system, comprising:
at least one inventory item storage receptacle having a moulded body including a plurality of inventory item storage locations, wherein each of the storage locations comprises an individually-shaped recess for receiving a specific inventory item, the shape of the recess being matched to the shape of the inventory item;
a monitoring system for monitoring the removal and replacement of the inventory items from the storage locations; and
a data processing system for recording the removal and replacement of inventory items from the recesses according to signals received from the monitoring system.

24. The inventory control system according to claim 23, wherein the moulded body of the storage receptacle comprises sheet material with the recesses moulded therein.

25. The inventory control system according to claim 23, wherein the storage receptacle is substantially ridged.

26. The inventory control system according to any one of claims 23, wherein the storage receptacle is substantially non-porous and substantially non-absorbent.

27. The inventory control system according to claim 23, wherein the storage receptacle is made from a plastics material, a curable polymer, a gel or a paste.

28. The inventory control system according to claim 23, wherein each inventory item recess includes formations that are arranged to retain the inventory item in the recess.

29. The inventory control system according to claim 23, wherein each inventory item recess includes formations that are arranged to provide tactile feedback to a user removing the inventory item from the recess and/or placing it therein.

30. The method according to claim 28, wherein the formations include at least one of the following: a substantially continuous overhanging lip that extends around the rim of the recess, one or more lip portions arranged to extend partially around the rim, an undercut portion and at least one protrusion or rib in a side wall the recess.

31. The inventory control system according to claim 23, wherein the receptacle includes a plurality of through holes for receiving equipment associated with the inventory item monitoring system.

32. The inventory control system according to claim 23, wherein the receptacle includes inventory item identification indicia adjacent each recess.

33. The inventory control system according to claim 23, wherein the storage receptacle includes textured areas in each recess and/or on the material surrounding each recess to provide an improved visual contrast between the recesses and the surrounding material.

34. The inventory control system according to claim 23, wherein the receptacle includes first and second sheets of mouldable material layered one on top of the other, with portions of one of the first and second sheets having been removed to expose the other of the first and second sheets.

35. The inventory control system according to claim 23, wherein the receptacle is coated with paint, dye, ink or similar in order to produce contrasting colours for the recesses and the surrounding material.

36. The inventory control system according to claim 23, wherein the receptacle is made from a deformable material, wherein the recesses have been formed by forcing an object having the shape of the tool into the material and then treating the material to fix the shape of the recesses.

37. The inventory control system according to claim 23, wherein the monitoring system includes at least one of a sensor system, a camera system with image recognition, a camera system with optical character recognition, and at least one barcode reading device.

38. The inventory control system according to claim 37, wherein the sensor system includes a plurality of sensors for sensing the presence of inventory items in the storage locations, each sensor being associated with a storage location and arranged to generate a signal representing the presence or absence of an inventory item in the associated storage location.
